(19) United States
(12) Patent Application Publication
(10) Pub. No.: US 2008/0297798 A1
(43) Pub. Date: Dec. 4, 2008

(54) Apparatus and Method to Monitor Particulates

(76) Inventor: Hans Wyssen, Zurich (CH)

Correspondence Address: Wyssen;Hans, Birmensdorferstrasse 467, Zurich, 8055, omitted

(21) Appl. No.: 11/994,547

(22) PCT Filed: Jun. 29, 2006
(86) PCT No.: PCT/EP06/63685

§ 371 Date: Jul. 21, 2008

Related U.S. Application Data
(60) Provisional application No. 60/595,580, filed on Jul. 18, 2005.

(51) Int. Cl. G01N 21/94; G01N 1/22

(52) U.S. Cl. 356/338; 356/244

(57) ABSTRACT

An apparatus, method and system for detecting and quantizing levels of specific airborne particle contamination in areas to be monitored for a plurality of users 201. Sealed particulate samplers 100 are distributed to a plurality of users 201. Samplers 100 are opened during a test period so that airborne particulate is pulled and affixed to surface 101 by means for attraction and affixing. After the test period, samplers 100 are sealed and sent to a processing center 200 where particulate affixed to surface 101 is analyzed using optical means and reports 203 generated and sent to users 201. Reports 203 compare test results with selected benchmark values from database 204.

### FIELD OF THE INVENTION

The present invention relates in general to detecting air particulates.

### BACKGROUND

Many facilities require monitoring of air particle contamination to ensure that the facilities maintain a desired cleanliness level. It is well known that air particles can be detrimental to human health as well as to sensitive equipment and processes. For example, air particle control is important in indoor applications, such as medical laboratories, hospitals, data centers and even more crucial in so called “clean rooms.” Clean rooms are necessary for the fabrication of sensitive semiconductor components such as integrated circuits which are extremely susceptible to contamination by airborne particulate. Companies have gone to great lengths to minimize the presence of airborne particles including the use of room air ionizers and filtration systems, but it is still necessary to monitor ambient particulate levels to ensure proper quality control during manufacturing operations. Clean rooms are also used in non-electronic manufacturing facilities, such as in the production of food and pharmaceuticals.

Airborne particulate levels in computer rooms or data centers need also to be monitored because sensitive computer equipment is vulnerable to airborne particulate such as cement dust which can contain corrosive salts or zinc whiskers that can cause electrical shorts. Zinc whiskers are crystals which can grow on galvanized metal surfaces. Due to their small size, these microscopic crystals can be transported by air currents into computer equipment and cause electrical shorts.

Airborne particulate can be dangerous to human health. The detrimental effects of asbestos fibers and other airborne particulate on the human body are well documented.

### PRIOR ART

It is known to monitor air particulate levels with instruments that make a side-scattered light measurement. Air is pumped through a sensor in which particles pass through a laser grid, interrupting the laser beam, thereby producing a pulses of light which are counted. These devices however have the following disadvantages:
1. Due to their complexity, these measuring devices are very costly. They are also costly to maintain since they must be calibrated regularly. Due to their high cost, the devises are generally only used in high security areas such as large computer rooms and clean rooms where their high cost can be justified. Due to their high cost they typically cannot be used, for example, by average homeowners.
2. Due to their complexity, these instruments are notoriously inaccurate and results can vary greatly between instruments.
3. The instruments do not actually image particles and provide at best only an estimate of the number of particles and their sizes.
4. The instruments are susceptible to contamination. Even a small amount of contamination in the internal sensor can cause inaccurate readings as well expose people to dangerous particulate. In fact, many companies which produce these instruments refuse to calibrate them if they are used in an environment where there is the possibility of biological contaminates.
5. They provide limited information regarding the particulate tested. They typically only measure the particle size and concentration and not particle shape, particle density or whether particles are inert or biological.

Another known air particle monitoring technique employs a witness plate which is placed in the clean work area so that fallout particles become deposited thereon by gravity or settlement.

Particle levels are recorded on each of the witness plates before they are placed in specific testing locations in the clean room. They are left undisturbed for a set amount of time and scanned again. The pre-test particle count is then subtracted from the post-test particle count and the number of “adders” is an indication of cleanliness levels in the particular area where the witness plate was located.

U.S. Pat. Nos. 6,122,053 (Arie Zwaal) and 3,526,461 (Lindahl) teach methods and apparatus using witness plates. After a predetermined time interval, the witness plate is inserted into an apparatus and illuminated at a grazing incidence by one or more light beams. A photo sensor mounted perpendicular to the witness plate detects scattered light from particles collected on the witness plate. The apparatus and methods taught in the prior art however have the following disadvantages:
1. Since there is no provision for sealing witness plates while being analyzed, equipment and personnel may be exposed to potentially hazardous particles which have collected on the witness plate. Also, additional particles not attributable to the area being monitored may be added to unsealed witness plates when they are moved to a measuring apparatus or during analysis, resulting in inaccurate test results.
2. There is no provision for affixing particulate that settle on witness plates. Therefore particulate which collected on the witness plate can be redistributed, disrupted or lost while the witness plate is moved to the measuring apparatus or during analysis, resulting in inaccurate test results.
3. Since no provision is made for providing clean, particle free and sterile witness plates which can be sealed and unsealed, witness plates must be scanned before and after collecting particulate. This makes the system slow, complicated to implement, as well as inaccurate. For example, witness plates which are not sterile cannot be trusted for use in analyzing biological particles.

A further disadvantage of the aforementioned “fallout sensors” where witness plates or settling plates rely on gravity to collect airborne particles, is that they are poor at collecting very small particulate. It well known that very small particles, for example, those smaller than 10 microns, tend to stay suspended in the ambient air rather then settling. This is a particularly big drawback since it is well known that such very small particles are a bigger threat to human health than larger particles, since they can travel deep into the lungs and even pass through the walls of the human lung and into the body's red blood cells. From there, they wreak health havoc, penetrating the body's cells and disabling them. Recent laboratory studies suggest that these ultrafine particles can be up to 50 times more damaging than bigger particles, possibly triggering heart attacks.

U.S. Pat. No. 5,870,186 describes a “particle fallout/activity sensor” where particle fallout settles on a rotating disk. The disk is illuminated with light radiation and digital images of the particulate are automatically processed to give information about particles settling thereupon.

This device however has the following disadvantages:
Is very expensive, since sophisticated digital imaging processing of particulate fallout is incorporated in the device.
Measurements tend to be inaccurate since the disk on which particles settle as well as sensors can become contaminated.
Since particle collection relies on gravity or settling, fine particles tend to remain suspended in the air rather then settling on the plate. Therefore the system cannot be relied upon for determining levels of fine particles.

U.S. Pat. No. 5,607,497 describes a passive dust sampler which uses a known electrostatic charge to attract and hold air particles. This device however has the following disadvantages:
Calculating the aerosol concentration of particles to which the sampler was exposed requires knowledge of the average aerosol mobility and electret charge, information that is difficult to determine accurately. This results in inaccurate reading.
The method for creating a known electrical charge on the dust collector surface is very complicated. A description of the method follows: First the collector surface must be charged using corona charging and then allowed to stabilize one week. Before and after the device is used, the surface electrical potential of the collector surface is measured and recorded.
While provision is made for the sampler to be transported in a dust free sachet. The sampler still must be taken apart in a dust free room and the dust collector portion removed to be analyzed. No provision is made to analyze the particles collected on the sampler without the need to open it. This can expose analytic equipment and persons to contamination collected in the sampler. It also opens the possibility of the sampler contents being exposed to contamination thereby producing inaccurate results.

U.S. Pat. No. 6,321,608 to Wagner et al. discloses a passive aerosol sampler which collects airborne particles using gravity, inertia, diffusion and electrostatic interaction. This device however has the following disadvantages:
No provision is made for charging the sampler with a substantially known electric charge for collecting particles. This can result in inaccurate estimates of levels of air particles.
No provision is made to analyze the particles collected in the sampler without opening it. This creates a risk of contaminating equipment, persons and the sampler thereby producing inaccurate test results. Regarding the processing method, U.S. Pat. No. 6,321,608 teaches “After a sample of aerosol particles has been collected with the passive aerosol sampler, the sampler is transported to the laboratory in a protective container such as described above. In the laboratory, the container is opened, the passive aerosol sampler is removed, the sampler body (SEM mount) is removed from the holder, and removable mesh cover is removed from the sampler body.”

Additionally, all the aforementioned prior art fail to give users truly meaningful reports which help users to determine if their levels of airborne particles are within acceptable parameters since for many rooms there is no standards as to what levels of air particles are within proper parameters. Their systems give users their levels of airborne particles, but inadequate benchmarks to which users can compare their test results in order to determine if their levels of airborne contamination are acceptable.

Even in rooms where particle limits have been defined e.g. cleanrooms, reports produced with the prior art often fail to inform users as to whether or not their levels of airborne particles really are acceptable. This is because their test results are often compared to benchmark standards which are often inadequate for the following reasons:
Competing standards often have different particle limits.
The scope of these standards is very limited in that they only define limits for a small group of particle types and sizes, for example, only a few particle sizes per volume unit of air.

Accordingly, several objects and advantages of the present invention, is to provide an air particle monitoring apparatus, method and system which:
Generates more meaningful reports since users can compare their test results with selected benchmark information based on actual measurements from a plurality of other users, for similar rooms, so that users can draw accurate conclusions regarding their levels of air particles.
Can be implemented at lower cost, since inexpensive sealable air particle samplers are transported to a remote processing center where they are analyzed. This is far less expensive than incorporating sensor/analytic technology within devices as with the prior art.
Provides users with more information about particulate than with prior art devices. Particulate information produced by the present invention can include particle size and concentration but also additional information about particle shape, density and whether particles are inert or biological.
Provides greatly improved accuracy, consistency and repeatability, since a plurality of particulate samplers are analyzed by one analytic measuring unit or sensor unit at a processing center and not individual sensors as with the prior art.
Does not expose persons to possibly dangerous contaminates since unlike the prior art, the sampler of the present invention is sealed after the test period, in the room where the testing was performed, and does not need to be opened again even when it is analyzed. This important feature of the present invention also prevents samplers from being contaminated after the test period resulting in inaccurate test results.
A device which, in the preferred embodiment is able to reliably collect even very small airborne particles which would not settle by gravity on the witness or settling plates used in the prior art.
A device which incorporates a means for creating a substantially known electrostatic charge to collect air particles which is simpler than the means taught in the prior art U.S. Pat. No. 5,607,497.

### SUMMARY OF THE INVENTION

In the embodiments of the invention described in more detail hereinafter, there is provided airborne particle monitoring apparatus, method and system where sealed, clean and sterile particle samplers are provided to a plurality of users in order to test levels of airborne particles in areas to be monitored. The particle samplers are opened in areas to be sampled during test periods. After the test period expires, samplers are sealed for transport to a processing center where particulate which collected in samplers is analyzed without the need to open the samplers. The processing center stores test results and user information in a database and generates reports which are sent to users. The reports compare test results with other test results and information stored in the database so that users can draw meaningful conclusions about levels of specific airborne particles.

Broadly stated, the invention provides a sampler for particulate material, comprising a member with a particle collection surface for particulate material, and a sealed cover that is removable to uncover the particle collection surface so that the surface can collect particulate material, the cover being configured to provide a sealed cover over the surface after collection of the particulate material, the sampler being in at least part thereof transparent to optical radiation to permit the particles on the particle collection surface to be analyzed optically with the cover sealed over the surface, and the sampler including an electrostatic charging device operable to charge the collection surface to attract particulate material thereto.

The invention also provides a method of sampling particulate material, comprising: providing a sampler comprising a member with a particle collection surface for particulate material, and a sealed cover that is removable to uncover the particle collection surface, the sampler being in at least part thereof transparent to optical radiation, removing the cover to expose the particle collection surface, placing the sampler at a sampling location so that the surface can collect particulate material, replacing the cover after a given time to provide a sealed cover for the surface with particulate material thereon, and performing an optical analysis of the particulate material on the particle collection surface by directing optical radiation into the sampler, without removing said cover.

The invention further provides a processing center for processing a sampler that comprises a member with a particle collection surface that has collected particulate material, and a sealed cover that has been removed to uncover the particle collection surface to collect the particulate material thereon and subsequently replaced to seal the particulate material in the sampler, the sampler being in at least part thereof transparent to optical radiation, the processing center including: an optical source to direct optical radiation into the sampler through a transparent portion thereof, a detector configured to detect optical radiation from the sampler, the processing center being configured to hold the sampler so that optical radiation is directed into the sampler from the source and returned to the detector having interacted with the particulate material without the cover being removed from the sampler, a database operable to compare particle data derived from the detector with stored benchmark values to generate a report concerning the particulate material, and a processor device configured to communicate the report to a user.

As used herein, the term “optical radiation” includes not only visible light but non-visible optical radiation such as ultra violet and infra-red.

### BRIEF DESCRIPTION OF THE DRAWINGS

In order that the invention may be more fully understood embodiments thereof will now be described by way of illustrative example with reference to the accompanying drawings in which:

FIG. 1 is a perspective view of the particle sampler from the top,

FIG. 2 is a perspective view of the particle sampler from the bottom,

FIG. 3 is a diametric cross sectional view of the particle sampler,

FIG. 4 is a perspective view of a particle measuring station for holding and protecting the sampler during a test period,

FIG. 5 is a schematic block diagram of a particle monitoring system in accordance with the present invention,

FIG. 6 is a vertical cross sectional view of apparatus used in a method of optically analyzing particulate collected in the particle sampler while it is sealed, and

FIG. 7 is a vertical cross sectional view of apparatus used in a method of optically analyzing particulate collected in the particle sampler while it is sealed.

### DETAILED DESCRIPTION

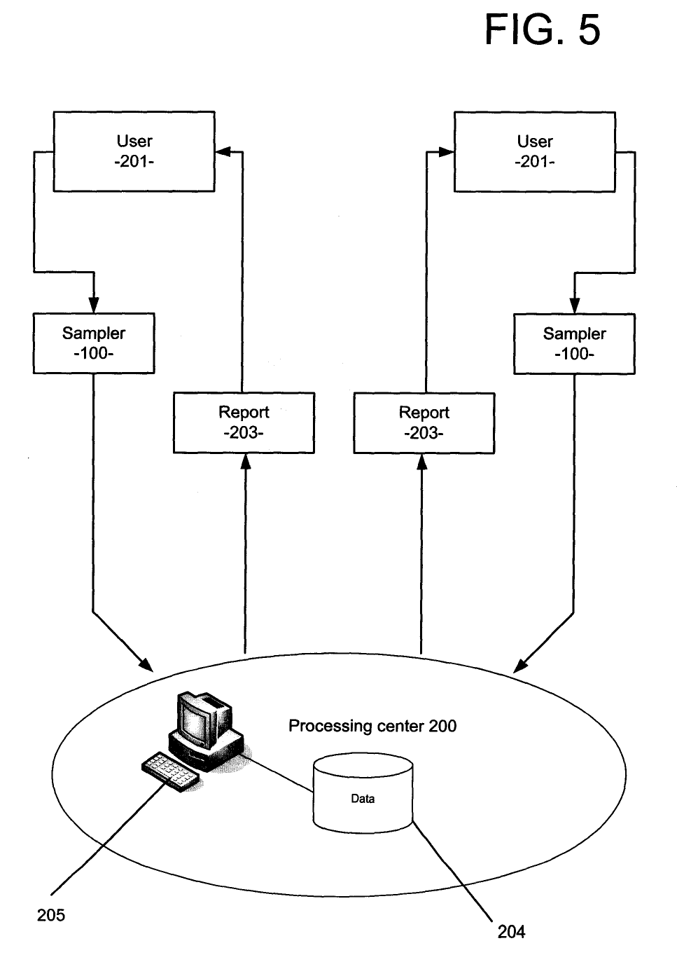

Referring initially to FIG. 5, a system for providing particle monitoring services to a plurality of users 201 is shown. Particle samplers 100 are provided to a plurality of users 201 in order to test contamination levels in areas to be monitored. After a test period, samplers 100 are sent to a processing center 200 where particulate which collected in samplers 100 is analyzed to produce reports 203 with test results, that are sent to the users 201.

The processing center 200 maintains a database 204 with test results from a plurality of samplers 100 along with information supplied by a plurality of users 201. The processing center 200 includes a processor device 205 that generates reports 203 that include test results from specific samplers 100 as well as selected information from database 204 which serve as references for benchmarks. By including selected benchmark values from database 204, users 201 can compare their test results to the benchmarks and gain important insights into their test results. The processor device 205 can email the reports to users or make them available through a website, as will be described in more detail later.

This is advantageous for users 201, since for many rooms there exists no clearly defined limits regarding what levels of specific airborne particles are acceptable or normal. Furthermore, levels of airborne particles can vary greatly due to numerous factors including geographical location, time of year, temperature, air pressure, air movement, air humidity, outside weather, building construction and how the room is used.

Even for cleanrooms, with defined particle limits, the benchmark information stored in database 204 can be very useful since:
Benchmark values in database 204 which are based on experience are more important than theoretical particle limits set by cleanroom classifications. For example, class limits are generally much higher than actual measurements in cleanrooms.
Classification limits only define levels for a few kinds of particles. For example the US Federal Standard 209D Class 100,000 has the following air particle limits per ft³ of air: 100 000@0.5 micron particles, 20 000@1.0 micron particles, 700@5.0 micron particles. There are no limits defined for levels of particles smaller than 0.5 microns, biological particles and fibrous particles. By comparing test results with values stored in database 204 users 201 can gain important insights regarding levels of particles not defined in class limits.

By comparing their test results with selected benchmark values from database 204, based on actual measurements in similar rooms from other users 201, users 201 are better informed as to whether their levels of airborne particles are lower or higher than normal levels for similar rooms. In using the benchmarks as described herein, it is generally assumed that test results which are below the selected benchmark levels from database 204 are acceptable and test results with particle levels which are higher than benchmark levels from database 204 are considered to be elevated.

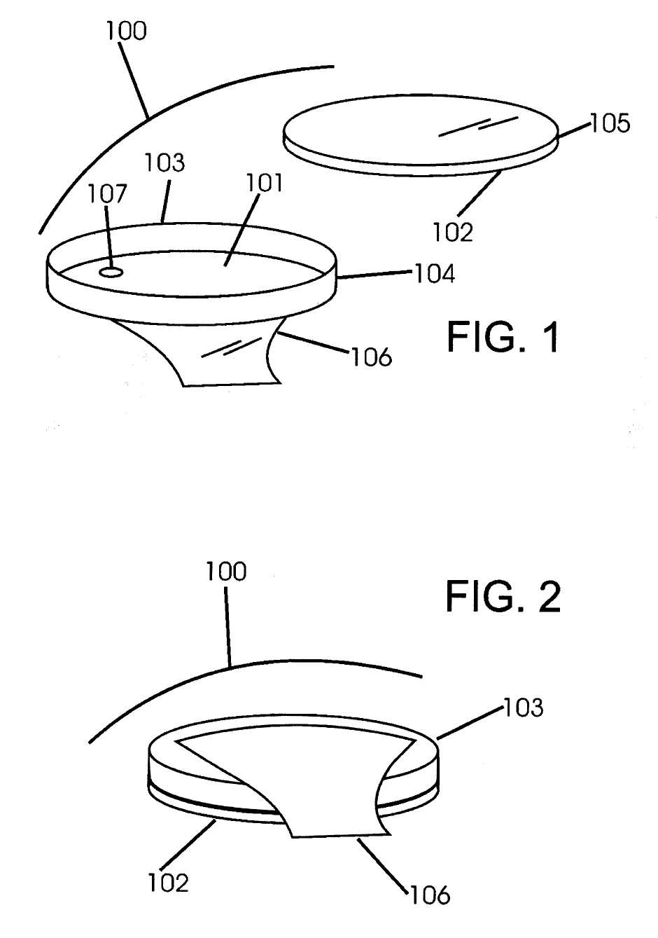

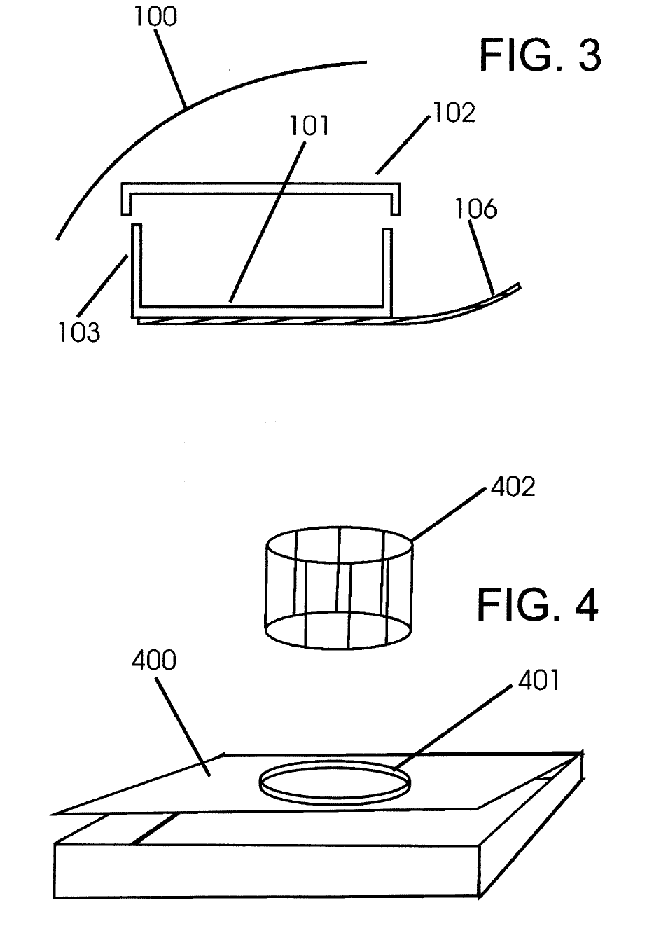

FIGS. 1-4 illustrate an example of the sampler 100, which is comprised of a base 103, a flat air particle collector surface 101 and a cover 102 which when connected to base 103, seals surface 101 from the ambient environment. In this example, the base is generally circular, with an upstanding, annular side wall 104. Cover 102 may be, for example, a friction fit lid or a screw-on lid and in this example is generally circular with a depending lip 105 for removably and sealingly engaging the annular side wall 104 of the base Its purpose is to substantially seal surface 101 from the ambient environment thereby protecting it from particle contamination before and after the test period. When opened or closed, the cover 102 does not make physical contact with surface 101.

When cover 102 is removed, surface 101 is exposed to the ambient environment in an area to be monitored. Airborne particles from the ambient environment are deposited on surface 101 during a testing period.

Being able to seal surface 101 from the ambient environment, has the following advantages:
1. With prior art witness wafers, levels of existing particle deposition had to be measured before they could be used and then this so called ground level contamination subtracted when the witness plates were analyzed after the test period. In the described example of the sampler, surface 101 is substantially particle free and sterile before being opened for the test period therefore making such pre-calibration unnecessary.
2. It makes it possible to transport sampler 100 to a remote location, away from the area being monitored, to be analyzed without danger of contaminating collected particulate on surface 101.

A further feature in the described sampler is that particulate collected on surface 101 can be analyzed without opening sampler 100. This is advantageous since:
Surface 101 is not exposed to possible particle contamination during analysis.
Persons who analyze samplers 100 are not exposed to possible hazardous particulate collected on surface 101.
Analytic equipment is not contaminated during analysis.

In order to make it possible to optically analyze surface 101, all or part of sampler 100 is made of substantially optically clear material such as, for example, transparent glass or plastic. A suitable, optically clear material is for example clear polystyrene (PSCL). The base 103 and cover 102 are preferably both made of transparent plastic. Surface 101 can be made of, for example, metal, glass or plastic. Depending on the type of optical analysis being done, surface 101 can:
be pigmented.
have a light absorbing color for example black, or a reflective, mirror surface or be transparent or opaque.
have a smooth or textured surface.
be a conductor or non-conductor of electricity.

Preferably, the surface 101 is flat, smooth, optically clear and a non-conductor.

The surface 101 has a means for affixing particulate collected thereupon. This is especially important for the following reasons:
It prevents fine particulate collected on surface 101 from becoming airborne again before sampler 100 is analyzed. This feature is particularly important in clean rooms and computer rooms, where there are often strong air currents.
It allows sampler 100 to be transported to processing center 200 without redistributing particulate which collected on surface 101. For example, if particles which collected on surface 101 are redistributed, this could result in inaccurate test results.

In the preferred embodiment of the present invention, electrostatic attraction is used as the affixing means. Using this affixing means is advantageous since surface 101 can be optically smooth, which is better suited for optically scanning or detecting small particles such as, for example, particles smaller than 10 microns. It has been found that electrostatic attraction can be used to securely affix particulate to surface 101. Additionally, fine particles such as for example, those with a diameter of less than 10 microns, will often not settle on surface 101 by gravitational force alone, but rather remain airborne. Electrostatic attraction has been found to be very effective at pulling these particles from the ambient air and affixing them to surface 101.

The method of using electrostatic charging to attract small particles is well known per se. For example, electrostatic charged mops and cloths are widely used for cleaning floor and other surfaces, where dust is attracted to electrostatically charged webs or fabrics. Dust particles which come in contact with electrostatically charged webs, become polarized by the electrostatic charges and will cling to the fabric.

Surface 101 can be charged with electrostatic electricity in various ways:

### Passive Triboelectric Charging:

Triboelectricity is the physics of charge generated through friction. As is known in the art, the Triboelectric Series is a list of materials, showing which ones have a greater tendency to become positively (+) charged and which ones have a greater tendency to become negatively (−) charged. The farther apart the materials are in the list, the greater the triboelectric charge will be. Air is at the top of the list and so has a tendency to become positively charged, so it is advantageous that surface 101 be made of a material which is lower in the triboelectric list, that is, has the tendency to become negatively charged. A suitable material is for example polystyrene, which has a tendency to become negatively charged. For example, it has been found that an acceptable electrostatic charge is generated when ambient air in an area being monitored moves over surface 101 when consisting of clear polystyrene (PSCL). Other suitable materials include: Teflon, Polyethylene, Polypropylene, Vinyl and Polyester.

### Separation Charging:

The method of charging by separation is similar to that of friction. When two materials are in contact, the surface electrons are in close proximity to each other and upon separation have a tendency to adhere to one material or the other dependent upon their relative positions on the Triboelectric Series.

Both separation charging and passive triboelectic charging can be used to charge surface 101 as will now be described. FIGS. 1-3 show an in-built charging device in the form of a detachable foil 106 which is affixed to the exterior of base 103 with a pressure sensitive adhesive that has different triboelectric properties from the material of base 103, so that when foil 106 along with the pressure sensitive adhesive, is pulled off base 103, an electrical charge is generated on surface 101. Foil 106 is preferably made of flexible sheet material such as, for example, plastic, paper or metal foil, and protrudes from sampler 100 so that it can be manually gripped and pulled off the sampler 100. Foil 106 may be, for example, a flexible, plastic, pressure sensitive adhesive tape coated with non-permanent, non-conductive, adhesive, and base 103 can be made of polystyrene.

In the preferred embodiment when foil 106 is removed, little or no adhesive separates from foil 106 and remains on sampler 100. For this reason, it is preferable that foil 106 be a tape with non-permanent or removable pressure sensitive adhesive which has a stronger bond to foil 106 than base 103.

The foil 106 is pulled off base 103 at the beginning of the test period. It has been found that when foil 106 is pulled off base 103, a substantially known static charge is produced on surface 101, and that a sufficient electrical charge can be sustained through passive triboelectric charging caused by ambient air making contact with surface 101. Also, it has been found that since reports 203 compare test results to samplers which were exposed to ambient air in rooms with similar environmental properties, the average electric charge on surface 101 is quite consistent with the average electric charges on samplers used in benchmark values selected from database 204. Since gravity and electrostatic forces are substantially constant, very accurate assumptions can be made by comparing test results with selected benchmark values from database 204 used in reports 203.

Furthermore, the method charging surface 101 with a substantially known electrical charge by pulling off foil 106, is much simpler than the method taught in U.S. Pat. No. 5,607,497 which describes complicated corona charging and measurement procedures in order to assure a known static electrical charge on their particle collection surface.

It has also been found that when sampler 100 is sealed with cover 102 and transported to the processing center 200, residual electrical charges on surface 101 remain sufficiently strong to securely hold particles which settled there upon during transport and while they are analyzed.

Surface 101 may, for example, be round and have a diameter of approximately 50 millimeters. Of course it may be smaller or larger or have some other shape. For example, it may be square or rectangular.

FIG. 4 shows a measuring station 400 which can be provided to users 201. In this example, station 400 is a container which can store a plurality of samplers 100. Station 400 can have a serial number which is linked to serial numbers of samplers 100 stored therein, in database 204. Measuring station 400 can be opened and closed. As shown in FIG. 4, this can be achieved by means of a lid or cover which is attached to measuring station 400 using, for example, a hinge. Measuring station 400 may also have a mount such as, for example, a socket 401 which holds sampler 100 during the test period. Station 400 may be placed on a horizontal surface or be configured with a means of affixing, so that station 400 may be mounted on a generally vertical surface such as a wall. For example, the station 400 may be configurable as a generally L shaped bracket to be affixed to the wall so as to support the sampler in a location out of reach of operatives who might spuriously touch the surface 101 and upset collected particle data. The aforementioned means of affixing may be, for example, pressure sensitive adhesive mounting tape.

Station 400 may also have a protector which protects the sampler 100 during the test period when mounted on measuring station 400 or when sampler 100 is placed on another surface during the test period. FIG. 4 shows a tube shaped protector 402 which may be placed over sampler 100. Protector 402 may be porous as the wire grid shown in FIG. 4 or be a solid tube type structure which is open at the top and bottom.

The analysis of particles collected on surface 101 can be performed at processing center 200 using optical analysis techniques including spectroscopy. Spectroscopy is the study of the interaction of light and matter. Light can be absorbed, reflected, transmitted, emitted or scattered by a substance at characteristic wavelengths (i.e., colors) of the electromagnetic spectrum (incl. gamma ray, X ray, ultraviolet (UV), visible light, infrared, microwave, and radio-frequency radiation) upon excitation by an external energy source. These characteristic wavelengths can then lead to the identification of the material's elemental and/or molecular composition. Spectral analytic equipment typically consists of a light source, a light-dispersing element i.e., prism or grating, to create a spectrum and a detection device.

The advantages of this method of analysis include:
Sampler 100 need not to be opened to be analyzed.
The analysis is non-invasive and non-destructive. Sampler 100 can be stored as a permanent record and be analyzed repeatedly. This is advantageous, for example, in court cases where damages are sought as a result of airborne contamination. In such cases sampler 100 can be used as evidence.

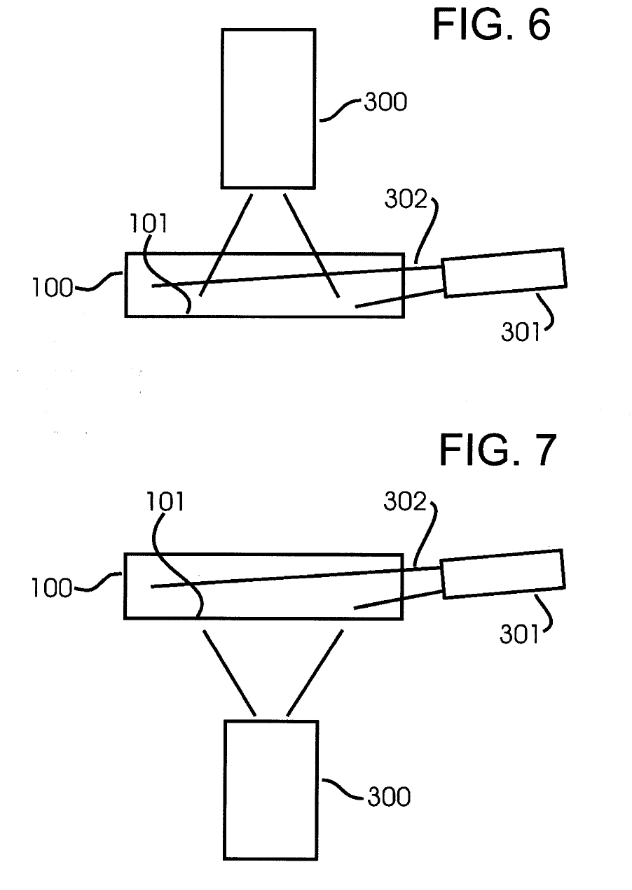

FIGS. 6 and 7 show various configurations of how surface 101 can be analyzed using optical analysis techniques. As known in the art, optical analysis of particles collected on surface 101 can be performed by directing one or more light beams 302 from one or more light sources 301 at various angles to the plane of surface 101. Particles present on surface 101 will reflect, transmit, emit or scatter characteristic wavelengths (i.e., colors) of the electromagnetic spectrum and this light is detected by a light sensor 300 which is preferably in a plane that extends approximately perpendicular to the surface 101. Light sensor 300 can, for example, be a camera with a photosensitive sensor surface. In the preferred embodiment data signals from light sensor 300 are processed by a computer and stored in database 204. As mentioned, sampler 100 is analyzed while in a sealed state. To make this possible, one or more portions of sampler 100 are substantially transparent to both light from beam 302 as well as to light traveling to sensor 300.

While the measuring area of light sensor 300 may be the same size as plate 101, it is advantageous that it be smaller than the area of plate 101 and that a plurality of images by made of surface 101 by light sensor 300. This allows the area of plate 101 to be larger and more measurements taken. For example, numerous pictures of surface 101 may be made until the entire area of surface 101 is scanned. In other cases, an area smaller than the total area of surface 101 can be scanned and by averaging the results of the individual pictures, an accurate determination of particulate collected be made.

For example, surface 101 may be circular and have a diameter of 50 millimeters, whereas the measuring area of light sensor 300 may be 4 millimeters by 6 millimeters. In this case, a plurality of pictures can be made of all or part of surface 101 with sensor 300 and an average of the resulting measurements then taken as the result. This provides improved accuracy over the prior art where only one measurement of the entire witness wafer is made as taught in UK Patent 1,145,657 by Saab Aktiebolag, U.S. Pat. No. 3,526,461 and U.S. Pat. No. 6,122,053.

Beam 302 can comprise light from the visible or invisible part of the electromagnetic spectrum. For example, light in the visible light spectrum, can be used to create particle images which can be used to determine particle size, shape and density. Images created using infrared and ultraviolet light can be used to create images that give additional information about the characteristics of particles collected in sampler 100. For example ultraviolet light can give information about whether particles are biological or inert.

For example, particles can be subjected to 340 nm, ultraviolet laser light and sensor 300 can detect the emission of fluorescence which is typically emitted from bacteria or bacterial spores. For example, fluorescence detected in the 400-540 nm range, while particles are being excited by 340 nm light, signals the presence of nicotinamide adenine dinucleotide hydrogen, which is indicative of biological activity or viability. Another useful excitation wavelength is 266 nm, which excites the amino acids tryptophan and tyrosine, which have peak emissions around 340 nm and 310 nm respectively. Infrared light is useful for determining material and chemical characterization of organic and inorganic compounds.

As shown by the aforementioned discussion, light radiation in various wavelengths, from different angles and intensities may be directed at particles collected on surface 101 and scattered light, reflected light or light emissions from the particles recorded by sensor 300.

Images of particles collected on surface 101 may be obtained using other wavelengths from the electromagnetic spectrum than the aforementioned examples and other methods of microscopy may be employed. These include:
X-ray spectrometry (including total reflectance X-ray spectrometry and X-ray fluorescence spectroscopy such as proton-induced X-ray emission spectroscopy)—elements with atomic number 1 to req. 8 or 10
X-ray powder diffraction—measures compounds rather than elements, detection limit poor—10.mu.g
Scanning electron microscopy (with energy) dispersive X-ray spectrometry and selected area diffraction)—size, shape, composition of particles.
Auger spectrometry
Reflectrance infra-red spectroscopy
UV spectroscopy

A plurality of images may be recorded while particles on surface 101 are exposed to different wavelengths of the electromagnetic spectrum using different methods of microscopy. By analyzing the spectral patterns on the particle images using analytic software, particle data for use in reports 203 may be generated. Such particle data can include one more items or combinations from the following list:
Particle size, shape and volume.
Chemical characteristics.
If a particle is biological or inert.
Particle density and weight.
Particle mass.
Fiber shaped particles.
Biological particles of a certain size.
Type of biological organism.
Type of micro fiber such as, for example, asbestos, or zinc whisker.

The test results in reports 203 are based on the collection rates for specific particles per square linear unit of surface 101 per time unit. For example, number of particles/cm² surface 101/day. The rate at which sampler 100 collects particles is related to the concentration of particles in the ambient air being measured. This means that the total number of specific particles collected by sampler 100 during the test period represents the average concentration of the specified airborne particles during the test period.

Below are examples of particle information which can be included in report 203:
Number of particles of a specified size/cm2/day
Total particle volume/cm²/day
Total particle surface area/m²/day
Number of fiber shaped particles/cm²/day
Total volume of biological particles/cm²/day
Total surface area of biological particles/cm²/day
Number of a certain particle type/cm²/day
Total particle mass/cm²/day

Other particle information and combinations thereof can be included in reports 203, depending upon the requirements of user 201.

Additionally, reports 203 preferably include one or more selected benchmark values from database 204 to help users draw meaningful conclusions from their test results.

Benchmark values selected from database 204 may be based on one, a plurality or a combination of the following criteria:
Type of building, for example, office building, hospital, apartment, house.
Room Size.
Air properties during the test period including, for example, temperature, humidity, velocity and density.
Room use, for example, library, restaurant, office, bedroom, living room, hospital.
Cleanroom classification.
Geographical area.
Time of year.
Distance from the floor where sampler 100 was placed.
Construction properties such as, for example, building materials, and information about the heating, ventilating, and air-conditioning system (HVAC).
Test results from another area of the same room.
Test results from the same room at an earlier date.
Test results from other rooms from the same user 201.

Processing center 200 can obtain some of the aforementioned information by, for example, including a paper form with sampler 100 which user 201 can fill out when sending sampler 100 for processing. If the length of the test period is determined by user 201 the start and end dates of the test period may also be noted.

While the aforementioned “air properties during the test period” can be provided by users 201, environmental logging means can also be incorporated into sampler 100. For example, known in the art are temperature labels which log temperature levels by chemical means and display test results by changing color. Such temperature indicator labels are widely used in the food industry. Chemical markers, logging temperature and other air properties can also be incorporated in sampler 100, for example, as a label 107 which is affixed directly on surface 101.

To make report 203 easier for users 201 to understand, test results can be shown as an index without any units of measure. For example if a sampler's test result was 250 0.5 micron particles per cm² of surface 101 per day and the selected benchmark value from data-base 204 is 500, the test result may simply be presented as:

Your test result: 250 Benchmark: 500

In the aforementioned example, the test results may also be multiplied by a constant. If for example the constant was 10 the results would appear as follows:

Your test result: 2500 Benchmark: 5000

Another way of presenting test results to users 201 is as a percentage of the selected benchmark from database 204 as shown in the following example: If user's 201 test result is 250 0.5 micron particles per cm² of surface 101 per day and the selected benchmark value from data-base 204 is 500 0.5 micron particles per cm² of surface 101 per day, test report 203 could show the test result as 50%. In this example, any test result which is 100 or less is good and any test result which is higher than 100 is elevated. Reports 203 can also employ graphs to graphically communicate test results.

### Operation:

Sealed samplers 100 are provided to users 201. It is important that surface 101 be substantially free of particulate and preferably sterile. To operate, user 201 opens sampler 100 by removing cover 102 in an area where air particle contamination is to be measured. The cover 102 is stored in a sealed container to protect it from contamination. For example, a sealable plastic bag may be provided for this purpose or cover 102 may be stored inside measuring station 400. The surface 101 is also given an electrical charge. This is accomplished by pulling foil 106 off sampler 100. This may be done at or about the same time that the cover 102 is removed. After charging, foil 106 may be discarded, saved or reattached to sampler 100. Sampler 100 is then preferably placed on a substantially horizontal surface in an area to be monitored. After the test period, sampler 100 is sealed with cover 102 and sent to processing center 200 along with user information. The length of the test period can be, for example, 24 hours, one week, one month, 3 months, 4 months or some other period of time.

Processing center 200 analyzes sampler 100 for particulate deposits as previously described and then sends user 201 report 203. Report 203 may be sent in paper form by mail or electronic form as electronic mail. Report 203 may also be accessed online at a website. Each sampler 100 may be provided with an identification code and password for opening its associated report, so that reports 203 can be securely accessed online from a website. If report 203 is sent using electronic mail it is preferable that the file be protected with an open password. Examples follow which illustrate the aforementioned methods:

### EXAMPLE 1

A homeowner is concerned about the presence of asbestos fallout coming from the renovation of an old building in the nearby area. He goes to a store and purchases a 24 hour air particle test kit. The kit contains one sampler 100. At home he removes cover 102 from sampler 100 and then pulls off foil 106 thereby charging surface 101. He places sampler 100 on a horizontal surface in the bedroom at a height of 150 cm from the floor.

After 24 hours the homeowner replaces cover 102 on sampler 100 thereby sealing it. On a paper form the homeowner writes his address and the type of room in which sampler 100 was placed, namely, in a residential house in the bedroom. He then sends sampler 100 along with the form to central processing center 200 using a preaddressed, padded envelope which was included in the kit. The homeowner then receives report 203 by mail with information about particles collected in sampler 100. Report 203 contains graphs which compare the collection rates of particulate of various sizes and types to average rates from other bedrooms, in the same town. The homeowner is relieved to see that the collection rates of particulate, including micro fibers is lower than the selected benchmark values from database 204.

### EXAMPLE 2

User 201 is a company which monitors particulate contamination in five class 100,000 computer rooms. As is known in the art a class 100,000 room has a limit of 100,000 half micron particles per cubic foot. At the entrance of each computer room there is a sign which reads: “Air Particle Levels in this room are constantly monitored with the DustCheck system.” As a result, workmen who do work in the rooms are extremely careful not to generate contamination, since they realize that contamination they generate would be registered. In each room there is a measuring station 400 placed on a horizontal surface. At the beginning of each month, sampler 100 that had been collecting particulate during the previous month is removed from the measuring station 400 and replaced with an unused sampler 100 stored in measuring station 400. The used sampler 100 is sealed with cover 102 and sent to processing center 200 for analysis. Processing center 200 sends the company reports 203 by email as files in the PDF format with open passwords. Reports 203 have graphs which compare particle levels in the user's different computer rooms with levels from previous months, as well as average levels of all class 100,000 computer rooms stored in database 204. In one report 203 the company is alerted to a large increase of small fiber shaped particles in one room. Further testing confirms high levels of zinc whisker contamination. The company implements immediate zinc whisker abatement before computer equipment can be harmed by zinc whiskers.

### EXAMPLE 3

User 201 is a company with an office building with 4 floors. At the door of the building there is a sign “For your protection, airborne particle levels in this building are monitored 24/7 by the DustCheck system”. On each floor there is a measuring station 400 placed on a horizontal surface. At the beginning of each month, the sampler 100 that had been collecting particulate during the previous month is removed from the top of measuring station 400 and replaced with an unused sampler 100 stored in measuring station 400. The used sampler 100 is sealed with cover 102 and sent to processing center 200 for analysis. Processing center 200 sends the company reports 203 by email as files in the PDF format with open passwords. Reports 203 have graphs which compare particle levels on the different floors with levels from previous test periods, as well as the average particulate levels of all similar office buildings stored in the data-base 204. In one report 203, the company is alerted to a large increase of biological particulate on one floor. An investigation reveals that the source of the biological contamination is a dirty ventilation air duct. The dirty air duct is cleaned which reduces levels of biological particulate to acceptable levels as shown by subsequent reports 203.

### EXAMPLE 4

Is the same as example 3 except that report 203 showed a general increase of particle fallout in the entire building. The cause was traced to a new cleaning company that was cleaning the building using vacuum cleaners which were not equipped with proper filters.

### EXAMPLE 5

Is the same as example 1 except that the homeowner placed sampler 100 in an outdoor balcony of his house.

### EXAMPLE 6

A patient went to a doctor complaining of respiratory ailments. The doctor gave the patient a 24 hour air particle test kit. Sampler 100 is opened for 24 hours in the home of the patient and then sent in for processing. Report 203 which was sent directly to the doctor revealed that particle volume levels where much higher than averages from homes in the same city, stored in database 204. Report 204 also showed that test results where higher than average test results for all patients whom the doctor had given the air particle test. After the installation of an air filter in the home, the patient felt much better. A follow-up air particle test showed that particle levels had dropped significantly.

As can be seen from the foregoing examples, the present invention is useful to users 201 since higher quality particulate monitoring and more meaningful test results can be made available to consumers. Samplers 100 are inexpensive to produce and since analysis is done at a central location for a plurality of users 203, a higher degree of accuracy can be achieved than with the prior art where analytic systems are built into the sampler unit. The use of the present invention will be particularly useful in indoor environments where particulate levels have been traditionally monitored such as for example: clean rooms, computer rooms, hospitals and food processing facilities. However, due to the lower cost of the described samplers in accordance with the present invention, high quality particulate monitoring may now also be made available to indoor environments where particulate monitoring with the prior art was prohibitively expensive. These include: residential homes, hotels, office buildings and restaurants. The use of the present invention will also be useful for people who suffer from asthma or because of sick building syndrome since the present invention gives an early warning of deteriorating or high levels of contamination so that steps may be taken to reduce particulate contamination. While particularly useful for monitoring indoor environments the present invention may also be used in outdoor environments.

Due to the low cost of individual samplers 100, a plurality of samplers 100 can be placed in more locations at a facility where particulate is to be monitored, giving users 201 a more complete picture of the level of contamination.

The system of the present invention makes it possible for test results to be compared with test results from other users 201 with similar rooms thereby giving users 201 a far more objective view of their test results.

### ALTERNATIVE EMBODIMENTS

In the foregoing description, the invention has been described with reference to specific embodiments thereof. It will, however, be evident that various modifications and changes may be made thereto without departing from the scope of the invention as defined in the following claims. For example, while in the described embodiment of the present invention both passive triboelectric charging and separation charging methods are used, sampler 100 may only use passive charging caused by ambient air contacting surface 101.

While one way of electrostatic charging surface 101 has been disclosed, there are other means of electrostatic charging which may be implemented. These include:

### Induction Charging:

It is known in the art that static charges can be generated when materials are in the presence of a strong electric field. For example, the surface of a material in close proximity to a high positive voltage will tend to become positively charged. In this embodiment surface 101 is placed in close proximity of a high voltage conductor with a voltage preferably greater than 1000 volts.

### Pre-Charging:

Another way of charging surface 101 is to place a material which has been pre-charged with static electricity in close proximity of surface 101, so that a charge is induced on surface 101. Known in the art are methods for producing materials which are pre-charged with static electricity and that can keep their charge for long periods of time. U.S. Pat. No. 4,215,682 (Kubik) teaches a method of producing such pre-charged materials.

Also, while in the preferred embodiment surface 101 is integrated into the base of a sealable sampler 100, surface 101, may be on a flat plate which can be placed in an area to be monitored. Before and after the test period the plate with surface 101 is sealed in a transport container, which is sufficiently transparent to enable particles collected on surface 101 to be optically analyzed without needing to be opened. The transport container may also have a means for securing the plate during transport.

While electrostatic means for affixing particulate to surface 101 is presently preferred, other means may also be used with or without electrostatic charging.

For example, these can include one or more methods from the following list:
Tacky surface. This can be an adhesive or a high surface tension elastomer. For example an acrylic pressure sensitive adhesive. It may also be a fluid coating such as for example, silicon oil or glycol which does not evaporate at room temperature.
Adhesive microstructure. As taught in U.S. Pat. No. 6,872,439, a fabricated microstructure comprised of microscopic protrusions at oblique angels relative to the plane of plate 101 exhibits adhesive abilities sufficient to hold particulate settling thereupon.

In an alternative embodiment of the present invention the pressure sensitive, adhesive coating on foil 106 remains on base 103, when foil 106 is removed from base 103, thereby providing a means of mounting sampler 100 on a surface in an area to be monitored as well as an electrical charge in surface 101. In this embodiment, a pressure sensitive adhesive is used, that has a stronger bond to base 103 than foil 106.

While in the surface 101 is preferably placed in a horizontal position when collecting airborne particle, surface 101 may alternatively be placed in a vertical position. This position can be advantageous when collecting and analyzing small particulate since larger particles which are too heavy to be attracted and affixed with an electrical charge will not be collected.

While the samplers 100 can be analyzed by one processing center 200, processing center 200 may also be a composite entity. For example, a plurality of facilities to analyze samplers 100 may be set up at different geographical locations and digital image data of particles collected in samplers 100 may be processed in one or more data-centers.

While in the described embodiment sampler 100 is provided to users 201 with foil 106 attached to sampler 100, sampler 100 may also be provided to user 201 with foil 106 detached from sampler 100. In this embodiment user 201 would attach foil 106 to sampler 100 and then pull it off thereby producing an electrical charge on surface 101. Also, whilst foil 106 is shown in FIG. 1 disposed on a portion of the base 103, it may cover the entire base or only a portion thereof depending on the level of charging required. The foil may be disposed so as to be operated as part of the act of removing the cover 102 from the base.

The specification and drawings are, accordingly, to be regarded in an illustrative rather than a restrictive sense.

1. A sampler (100) for particulate material, comprising a member (103) with a particle collection surface (101) for particulate material, and a sealed cover (102) that is removable to uncover the particle collection surface so that the surface can collect particulate material, the cover being configured to provide a sealed cover over the surface after collection of the particulate material, the sampler being in at least part thereof transparent to optical radiation to permit the particles on the particle collection surface to be analysed optically with the cover sealed over the surface, and the sampler including an electrostatic charging device (106) operable to charge the collection surface to attract particulate material thereto.

2. A sampler according to claim 1 wherein the electrostatic charging device is detachable so as to charge the collection surface by triboelectric separation charging.

3. A sampler according to claim 2 wherein the electrostatic charging device comprises a detachable foil (106) configured to charge the collection surface when detached from the sampler.

4. A sampler according to any preceding claim wherein the charging device is attached to the member (103).

5. A sampler according to claim 4 wherein the charging device comprises a detachable foil (106) which is affixed to the member (103) with a pressure sensitive adhesive which has different triboelectric properties from the material of said member (103) so that when the foil along with the pressure sensitive adhesive is pulled off the member (103) an electrical charge is generated on the particle collection surface (101).

6. A sampler according to claim 4 including a self adhesive that attaches the foil and that adheres preferentially to the member (103) when detached.

7. A sampler according to any preceding claim wherein the charging device (106) is operable to apply a substantially predetermined electrostatic charge to the particle collection surface.

8. A sampler according to any preceding claim wherein the particle collection surface (101) is configured to be electrostatically charged by passive triboelectric charging caused by ambient air passing over the particle collection surface when the cover is removed.

9. A sampler according to any preceding claim wherein the member (103) comprises a generally circular base with an upstanding annular side wall (104) to which the cover is fitted.

10. A sampler according to any preceding claim wherein the member (103) is at least in part transparent to optical radiation.

11. A sampler according to any preceding claim wherein the cover is at least in part transparent to optical radiation.

12. A sampler according to any preceding claim at least in part made from polystyrene, Teflon, polyethylene, polypropylene, vinyl or polyester.

13. A sampler according to any preceding claim including a device (107) for logging a property of the ambient air to which the particle collection surface is exposed when the cover (102) is removed therefrom.

14. A method of sampling particulate material, comprising:
providing a sampler (100) comprising a member (103) with a particle collection surface (101) for particulate material, and a sealed cover (102) that is removable to uncover the particle collection surface, the sampler being in at least part thereof transparent to optical radiation,
removing the cover (102) to expose the particle collection surface (101),
placing the sampler (100) at a sampling location so that the surface (101) can collect particulate material,
replacing the cover after a given time to provide a sealed cover for the surface (101) with particulate material thereon, and
performing an optical analysis of the particulate material on the particle collection surface by directing optical radiation into the sampler, without removing said cover.

15. A method according to claim 15 including providing the particle collection surface (101) so that particulate material is attracted from the air onto the surface.

16. A method according to claim 15 including providing an electrostatic charge on the particle collection surface (101).

17. A method according to claim 16 including providing an in-built electrostatic charging device (106) on the sampler, and operating the charging device to charge the particle collection surface.

18. A method according to claim 17 including operating the charging device at or about the time when the cover is removed to expose the particle collection surface.

19. A method according to claim 17 wherein the electrostatic charging device (106) comprises a detachable foil (106), and including detaching the foil so as to charge the particle collection surface by triboelectric separation charging.

20. A method according to any one of claims 14 to 19 including transporting the sampler with the cover replaced thereon to a processing center (200), and performing said optical analysis at the processing center.

21. A method according to any one of claims 14 to 20 including directing a beam of optical radiation into the sampler and detecting optical radiation returned from the sampler as a result of the particulate material on the particle collection surface interacting with the beam.

22. A method according to claim 20 including performing an analysis of the detected, returned radiation to provide particle data corresponding to an estimate of characteristics of the particulate material on the particle collection surface.

23. A method according to claim 21 including performing said analysis of the detected, returned radiation to provide particle data corresponding to an estimate of the number particles per unit area on the particle collection surface.

24. A method according to claim 21 including performing said analysis of the detected, returned radiation to provide particle data corresponding to an estimate of the size of particles on the particle collection surface.

25. A method according to claim 21 including performing said analysis of the detected, returned radiation to provide particle data corresponding to an estimate of at least one of the size, shape and volume of particles on the particle collection surface.

26. A method according to claim 21 including performing said analysis of the detected, returned radiation to provide particle data corresponding to the material composition of particles on the particle collection surface.

27. A method according to claim 21 including performing said analysis of the detected, returned radiation to provide particle data corresponding to an indication of biological characteristics of particles on the particle collection surface.

28. A method according to any one of claims 21 to 27 including comparing the particle data with corresponding benchmarks stored in a database (204) and producing a report based on the comparison concerning the particulate material collected by the sampler.

29. A method according to any one of claims 21 to 28 including receiving logging data corresponding to conditions during which the particulate material was collected on the particle collection surface, and utilising the logging data and the particle data to generate a report concerning the particulate material collected by the sampler.

30. A method according to claim 29 wherein the logging data includes the period of time that the particulate material was collected and generating the report concerning the particulate material collected by the sampler taking into account said period of time.

31. A method according to claim 29 or 30 wherein the report includes comparison data based on a comparison of the particle data for particulate material collected by the sampler with benchmarks based on samples with corresponding associated logging data.

32. A method according to claim 29, 30 or 31 including providing an identity for the sampler and associating the report with the identity of the sampler.

33. A method according to claim 32 including providing security protected access to the report for a user corresponding to the identity for the sampler.

34. A method according to claim 32 or 33 including making the report available to the user through a website.

35. A method according to claim 32 or 33 including emailing the report to the user.

36. A method according to any one of claims 14 to 35 including directing optical radiation of a first wavelength characteristic at the sampler and detecting optical radiation with a second different wavelength characteristic returned from the sampler.

37. A report produced by a method as claimed in any one of claims 28 to 35.

38. A processing center (200) for processing a sampler (100) that comprises a member (103) with a particle collection surface (101) that has collected particulate material, and a sealed cover (102) that has been removed to uncover the particle collection surface to collect the particulate material thereon and subsequently replaced to seal the particulate material in the sampler, the sampler being in at least part thereof transparent to optical radiation, the processing center including: an optical source (301) to direct optical radiation into the sampler through a transparent portion thereof, a detector (300) configured to detect optical radiation from the sampler, the processing center being configured to hold the sampler so that optical radiation is directed into the sampler from the source and returned to the detector having interacted with the particulate material without the cover being removed from the sampler, a database (204) operable to compare particle data derived from the detector with stored benchmark values to generate a report concerning the particulate material, and a processor device (205) configured to communicate the report to a user.

39. A processing center according to claim 38 wherein the processor device (205) is operable to email the report to a user.

40. A processing center according to claim 38 wherein the processor device (205) is operable to make the report available to a user through a website.

41. A measuring station comprising a container to receive at least one sampler as claimed in any one of claims 1 to 13, and a mount (401) to receive the sampler with its cover removed for collecting particulate material.

42. A measuring station according to claim 40 or a sampler as claimed in any one of claims 1 to 13 including a guard (402) to surround the collection surface (101) whilst the cover is removed for collecting particulate material.

43. A measuring station according to claim 40 or a sampler as claimed in any one of claims 1 to 13 including a container to receive the cover whilst removed from the sampler.

44. A measuring station comprising a sampler as claimed in any one of claims 1 to 13 and a bracket (400) to mount the sampler on a generally vertical surface.
